(19) United States
(12) Patent Application Publication
(10) Pub. No.: US 2020/0091587 A1
(43) Pub. Date: Mar. 19, 2020

(54) PORTABLE COMMUNICATION DEVICE

(71) Applicant: NIPPON SEIKI CO., LTD., Niigata (JP)

(72) Inventors: Hideki MASUDA, Niigata (JP); Yuu TATSUUMI, Niigata (JP); Kazuo MOROHASHI, Niigata (JP)

(21) Appl. No.: 16/340,309

(22) PCT Filed: Oct. 13, 2017
(86) PCT No.: PCT/JP2017/037149

§ 371 Date: Apr. 8, 2019

(30) Foreign Application Priority Data
Oct. 24, 2016 (JP) 2016-207543

(51) Int. Cl. H01Q 1/24; H01Q 1/38; H01Q 9/04; H01Q 7/06

(52) U.S. Cl. CPC H01Q 1/243; H01Q 7/06; H01Q 9/0421; H01Q 1/38

(57) ABSTRACT

Provided is a portable communication device that can be used in a hazardous location. In a portable communication device provided with an antenna and a case accommodating the antenna, the case comprises at least two divided bodies, namely a lower case which is a first divided body, and an upper case which is a second divided body. At least a portion of the divided body which faces the antenna, being either one of the two divided bodies, is formed from an electrically insulating resin satisfying explosion-resistance requirements, and the other divided body is made from an electrically conductive resin.

### TECHNICAL FIELD

The present invention relates to a portable communication device, for example, relates to a portable communication device usable in a location such as a plant and a factory where explosion-resistance is required.

### BACKGROUND ART

Conventionally, a portable communication device constitutes a part of an instrument status collection system. A conventional technology related to such a portable communication device is disclosed in Patent Document 1.

### PRIOR ART DOCUMENT

### Patent Document

Patent Document 1: Japanese Unexamined Patent Application Publication No. 2016-139227

### SUMMARY OF THE INVENTION

### Problems to be Solved by the Invention

A portable communication device as described in the conventional technology needs to be assumed to be used in a hazardous location such as a plant and a factory. The hazardous location means a location where flammable gas may mix with air to generate a dangerous atmosphere not less than the lower explosion limit in a plant, a factory, or the like. A communication device assumed to be used in such a hazardous location must comply with intrinsic safety explosion-resistance requirements (JIS C60079).

An object of the present invention is to provide a portable communication device usable in a hazardous location, as a result of focusing on the above problem.

### Solution to Problem

A portable communication device according to the present invention includes an antenna and a case configured to accommodate the antenna. The case includes at least two divided bodies, namely a first divided body and a second divided body. At least a portion of the divided body facing the antenna of either one of the two divided bodies is made of an electrically insulating resin satisfying explosion-resistance requirements and the other divided body is made of a conductive resin.

Further, a portion not facing the antenna of the divided body made of the electrically insulating resin satisfying explosion-resistance requirements is made of a conductive resin.

Further, the conductivity of the conductive resin is 10⁹Ω or less in an environment of 50±5% relative humidity, or 10¹¹Ω or less in an environment of 30±5% relative humidity.

In addition, the antenna has an antenna pattern printed on an insulating material made of polyimide or polyethylene terephthalate, and a magnetic sheet is provided on the back surface of the insulating material.

Further, the device includes a circuit board configured to connect to the antenna and a spacer is provided between the antenna and the circuit board.

Further, an operation display unit configured to notify an operation of the portable communication device is provided.

Further, the operation display unit is provided in the divided body made of the conductive resin.

### Effect of the Invention

The present invention can provide a portable communication device usable in a hazardous location.

### BRIEF DESCRIPTION OF THE DRAWINGS

FIG. 1 is a diagram schematically illustrating an instrument status collection system in which a portable communication device according to an embodiment of the present invention is employed.

FIG. 2 is an exploded perspective view of the portable communication device illustrated in FIG. 1.

FIG. 3 is a cross-sectional view of the portable communication device illustrated in FIG. 1.

FIG. 4 is a plan view of an antenna.

FIG. 5 is a cross-sectional view taken along line A-A of FIG. 4.

### MODE FOR CARRYING OUT THE INVENTION

An embodiment of the present invention will be described with reference to the attached drawings, below.

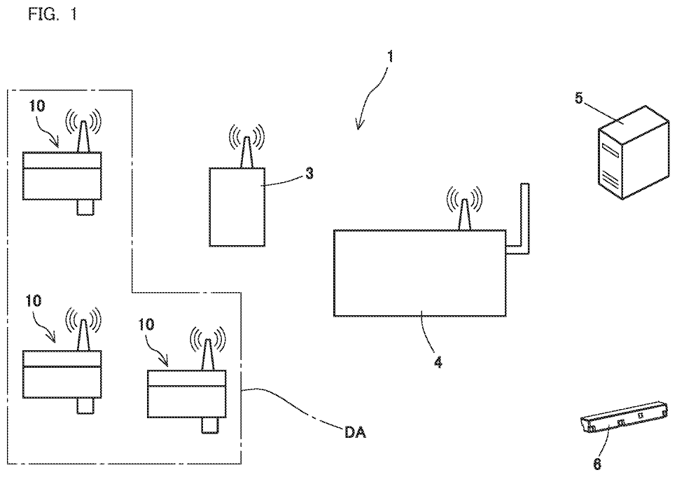

Now, reference is made to FIG. 1. FIG. 1 illustrates an instrument status collection system 1 in a petrochemical plant. The petrochemical plant is very vast. Therefore, the status of each instrument is detected by a detection device 10, and the detected information is managed in a data storage management device 5.

The embodiment will now be described in more detail. A plurality of detection devices 10 each of which is attached to each instrument in the plant are arranged in a hazardous location DA. Information detected in the detection devices 10 is transmitted to a network construction device 4 via a repeater 3 and transmitted to the data storage management device 5. An administrator of the plant can use an unillustrated notebook computer (management terminal) to confirm the information stored in the data storage management device 5.

Although three detection devices 10 are illustrated in FIG. 1, four or more, or one or two detection devices 10 may be provided.

Examples of the status detected by the detection device 10 include temperature and vibration. Upon recognizing an abnormality of the status, the administrator sends an operator to the detection device 10 which has detected the abnormality to check the abnormality.

The plurality of detection devices 10 are arranged in the plant, and thus the operator holds a portable communication device 6 over the detection device 10 to check whether the device is the detection device 10 detecting the abnormality to perform radio communication. Further, when the detection device 10 is set, setting information set by the portable communication device 6, operator information, work contents, and the like can be wirelessly written into the detection device 10. For communication between the portable communication device 6 and the detection device 10, the standard of NFC (Near Field Communication) being short-range radio communication can be employed. For example, if the device is the detection device 10 detecting the abnormality, a display unit of the detection device 10 or an operation display unit described later of the portable communication device 6 indicates that the device is the detection device 10 detecting the abnormality.

The portable communication device 6 includes a case 61, a circuit board 62, a spacer 63, an antenna 64, a battery 65, a power switch knob 66, and an active switch knob 67. It is noted that 68 is a diffusion member included in the operation display unit.

The case 61 includes two divided bodies, a first divided body is a lower case 69, and a second divided body is an upper case 70. The lower case 69 and the upper case 70 are fixed by a fastening member such as an unillustrated bis. The case 61 accommodates the circuit board 62, the spacer 63, the antenna 64, and the battery 65. The power switch knob 66 and the active switch knob 67 are movably mounted on the case 61, and the diffusing member 68 is fixed so as to be partially exposed from an opening provided in the case 61.

The lower case 69 has a cup shape having a concave part 71, and the circuit board 62, the spacer 63, the antenna 64, and the battery 65 are accommodated in the concave part 71. The material of the lower case 69 includes a conductive resin mixed with a material such as carbon having conductivity. ABS resin or polyacetal is suitable for a synthetic resin being the conductive resin, and in the present embodiment, ABS resin is employed. Preferably, the conductivity of the conductive resin is less than 10⁹Ω in an environment of 50±5% relative humidity, or less than 10¹¹Ω in an environment of 30±5% relative humidity. The material of the lower case 69 has conductivity, and thus accumulation of static electricity on the lower case 69 can be suppressed.

In addition, on the bottom of the lower case 69, an operation display unit 72 configured to notify the operation status is formed. On the operation display unit 72, light from a light source 73 such as a light emitting diode mounted on the circuit board 62 can be visually recognized through the diffusion member 68. The diffusing member 68 is made of milky white synthetic resin capable of transmitting light, and diffuses the light from the light source 73, so that the light from the light source 73 cannot be directly viewed. It is noted that in the present embodiment, three operation display units 72 are provided, each of which includes a tubular body 74 included in an illumination room. With the tubular body 74, the light from the light source 73 does not leak to another operation display unit 72 not to affect the display of the operation display unit 72.

The upper case 70 included in the case 61 has a substantially flat plate shape and blocks an opening of the concave part 71 of the lower case 69. The upper case 70 is a divided body facing the antenna 64, and the material of the upper case 70 is a resin having an electrical insulation and is made of a synthetic resin not containing a conductive material such as carbon. The suitable synthetic resin in this embodiment is ABS resin and polyacetal. In the present embodiment, ABS resin is employed. In the present embodiment, the surface area of the upper case 70 is 10000 mm² or less to satisfy the explosion-resistance requirements.

The circuit board 62 has a predetermined wiring pattern on a hard base material made of glass fiber-containing resin, and the light source 73, unillustrated electronic parts, and the like are mounted thereto.

The spacer 63 is made of a synthetic resin, in this embodiment, ABS resin, and is to install the antenna 64. The spacer 63 has a table shape, and includes a top plate portion 63A and a leg 63B to support the antenna 64 on the top plate portion 63A. The spacer 63 allows the antenna 64 to rest proximally to the upper case 70 and maintains a certain distance from the wiring pattern of the circuit board 62 to ensure insulation.

The antenna 64 has the antenna pattern 64A printed and formed on one side of an insulating material having flexibility such as polyimide or polyethylene terephthalate, in the present embodiment, an insulating plate shaped base material 64D. The antenna pattern 64A is formed so as to surround the vicinity of the outer periphery of the rectangular base material 64D with a double rectangle. The above shape of the antenna pattern 64A provides a coil formed on the base material 64D. It is noted that the antenna 64 includes a connection piece 64C on a portion of the base material 64D to connect the connection piece 64C to the connector 62A formed on the circuit board 62 for electrical connection.

On the antenna 64, if a side of the base material 64D on which an antenna pattern 64A is provided is regarded as a surface, a magnetic sheet 64B is affixed on a back surface being the opposite side. This magnetic sheet 64B is made of a sintered ferrite, adjusted so as to have characteristics with high magnetic permeability in the communication frequency band and little loss, and has a magnetic shielding function. The electric wave occurring at the antenna 64 is reflected without passing through the magnetic sheet 64B side to be reflected on a side on which the antenna pattern 64A is provided, and thus the electric wave is transmitted toward a surface side of the antenna 64 without being affected by the circuit board 62 on the back surface side of the antenna 64, allowing to further extend the communication distance because of the characteristics with little loss. It is noted that the antenna pattern 64A is covered with an unillustrated protective material to protect the antenna pattern 64A.

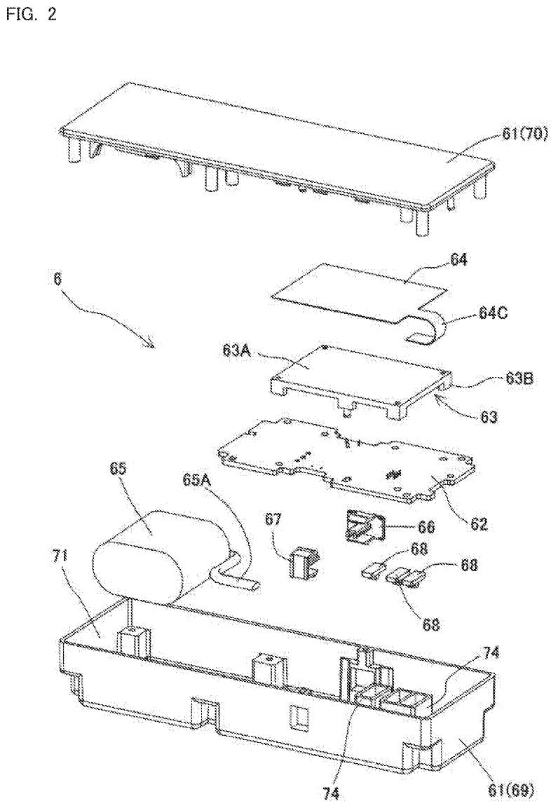

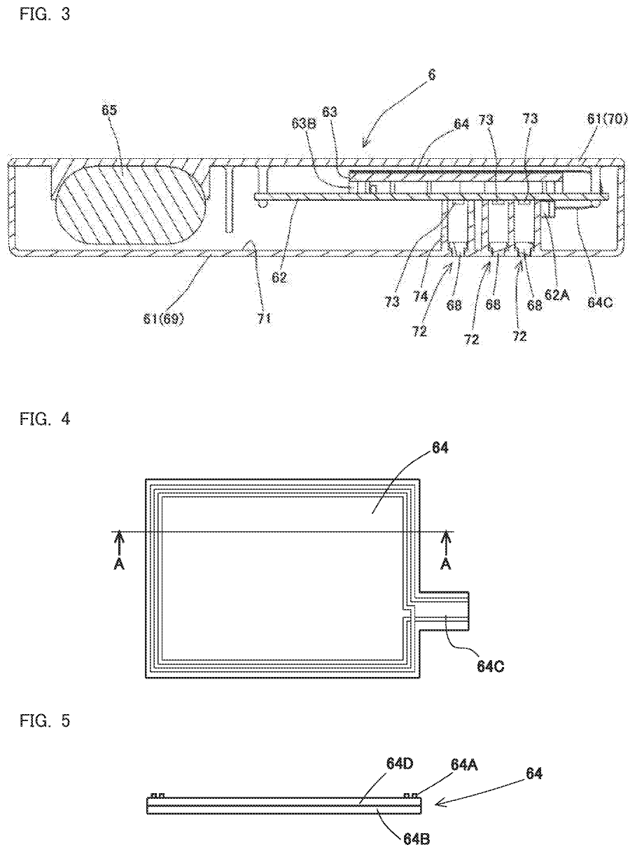

The battery 65 supplies electric power to an unillustrated circuit formed on the circuit board 62, the antenna 64, and the like. In the present embodiment, the battery 65 is a battery pack in which two lithium primary cells are connected in parallel, and connects to the circuit board 62 by an unillustrated connector. It is noted that 65A in FIG. 2 is a wiring of the battery 65 a part of which is illustrated.

The power switch knob 66 is made of a synthetic resin, and is to operate an unillustrated switch element provided on the circuit board 62. The power switch knob 66 is operated to turn on and off the main power supply of the portable communication device 6.

The active switch knob 67 is made of a synthetic resin, and is to operate an unillustrated switch element provided on the circuit board 62. The active switch knob 67 is operated to turn on and off the communication function of the portable communication device 6.

With the above configuration, the plurality of detection devices 10 are arranged in the hazardous location DA. This allows an operator to hold the portable communication device 6 over the detection device 10 to check whether or not the detection device 10 is detecting an abnormality. For example, when the detection device 10 is detecting an abnormality, the operation display unit 72 of the portable communication device 6 is lighted.

As described above, the portable communication device 6 includes the antenna 64 and the case 61 configured to accommodate the antenna 64. The case 61 includes at least two divided bodies configured by the first divided body 69 and the second divided body 70. At least a portion of the divided body 70 facing the antenna 64 of either one of the two divided bodies 69, 70 is made of an electrically insulating resin satisfying explosion-resistance requirements and the other divided body 69 is made of a conductive resin, thereby providing the portable communication device 6 usable in the hazardous location DA.

Further, the conductivity of the conductive resin is 10^{9Ω} or less in an environment of 50±5% relative humidity, or, 10^{11Ω} or less in an environment of 30±5% relative humidity, and thus an explosion due to a spark caused by static electricity can be suppressed, because of an antistatic effect of the conductive resin, even if a charged person touches the device in the atmosphere of the flammable gas in the hazardous location DA.

Further, the antenna 64 has the antenna pattern 64A printed on the insulating material made of polyimide or polyethylene terephthalate and the magnetic sheet 64B is provided on a back surface of the insulating material to provide characteristics with high magnetic permeability in the communication frequency band and little loss, thereby an electric wave transmitted from the antenna 64 is transmitted toward a surface side without being affected by the circuit board 62 on the back surface side, allowing to further extend the communication distance because of the characteristics with little loss.

In addition, the circuit board 62 configured to connect to the antenna 64 is provided, and the spacer 63 between the antenna 64 and the circuit board 62 is provided, and thus the antenna 64 can be arranged proximally to the upper case 70 and a certain distance can be maintained from the wiring pattern of the circuit board 62 to ensure insulation.

Further, the operation display unit 72 configured to notify the operation of the portable communication device 6 is provided to visibly check the operation of the portable communication device 6.

In addition, the operation display unit 72 is provided on the divided body 69 made of the conductive resin, and thus an explosion due to a spark caused by static electricity can be suppressed, because of the antistatic effect of the conductive resin, even if a charged person touches the device in the atmosphere of the flammable gas in the hazardous location DA.

Next, a second embodiment of the present invention will be described.

In the first embodiment, the upper case 70 included in the case 61 was made of only a resin having electrical insulation properties. However, to satisfy explosion-resistance requirements stricter than the first embodiment, an electrically insulating resin is used for only a portion of the upper case 70 facing the antenna 64 so as to satisfy the explosion-resistance requirements, the upper case 70 being the second divided body made of an electrically insulating resin satisfying the explosion-resistance requirements, and a portion wanting to face the antenna 64 may be made of the conductive resin. In this case, the upper case 70 as the second divided body is made of two types of resins, the electrically insulating resin and the conductive resin. In this case, different materials of the electrically insulating resin and the conductive resin can be combined to be formed integrally, and different materials can be coupled by a mechanical coupling means.

As described above, a portion not facing the antenna 64 of the divided body 70 made of the electrically insulating resin satisfying the explosion-resistance requirements is made of the conductive resin, and thus the portable communication device 6 having explosion-resistance property can be provided while influence on communication can be suppressed.

It is noted that in the above-described embodiment, although the case 61 is divided into two parts being the lower case 69 and the upper case 70, the case is not limited to being divided into two, and the case may be divided into three.

In addition, to satisfy the explosion-resistance requirements, the surface area of the electrically insulating resin is not limited to that in the aforementioned embodiments, and can be arbitrarily changed depending on required explosion-resistance requirements.

### INDUSTRIAL APPLICABILITY

The present invention is suitable for a portable communication device to be employed in a hazardous location such as a plant and a factory.

### DESCRIPTION OF REFERENCE NUMERALS

1 Instrument status collection system
3 Repeater
4 Network construction device
5 Data storage management device
6 Portale communication device
10 Detection device
61 Case
62 Circuit Board
62A Connector
63 Spacer
63A Top plate portion
63B Leg
64 Antenna
64A Antenna pattern
64B Magnetic sheet
64C Connection piece
64D Base material
65 Battery
66 Power source switch knob
67 Active switch knob
68 Diffusion member
69 First divided body (lower case)
70 Second divided body (upper case)
71 Concave part
72 Operation display unit
73 Light source
74 Tubular body
DA Hazardous location

1. A portable communication device comprising: an antenna; and a case configured to accommodate the antenna, wherein the case is configured by at least two divided bodies of a first divided body and a second divided body, and at least a portion of a divided body facing the antenna of either one of the two divided bodies is made of an electrically insulating resin satisfying explosion-resistance requirements and the other divided body is made of a conductive resin.

2. The portable communication device according to claim 1, wherein a portion not facing the antenna of the divided body made of the electrically insulating resin satisfying the explosion-resistance requirements is made of a conductive resin.

3. The portable communication device according to claim 1, wherein the conductivity of the conductive resin is 10⁹Ω or less in an environment of 50±5% relative humidity, or 10¹¹Ω or less in an environment of 30±5% relative humidity.

4. The portable communication device according to claim 1, wherein the antenna has an antenna pattern printed on an insulating material made of polyimide and polyethylene terephthalate, and a magnetic sheet is provided on a back surface of the insulating material.

5. The portable communication device according to claim 1, comprising a circuit board configured to connect to the antenna, wherein a spacer is provided between the antenna and the circuit board.

6. The portable communication device according to claim 1, wherein an operation display unit configured to notify an operation of the portable communication device is provided.

7. The portable communication device according to claim 6, wherein the operation display unit is provided in the divided body made of the conductive resin.
